(19) United States
(12) Patent Application Publication
(10) Pub. No.: US 2007/0085016 A1
(43) Pub. Date: Apr. 19, 2007

(54) X-ray detector

(76) Inventor: Reiner Franz Schulz, Dormitz (DE)

Correspondence Address: SCHIFF HARDIN, LLP;PATENT DEPARTMENT, 6600 SEARS TOWER, CHICAGO, IL, 60606-6473, US

(21) Appl. No.: 11/528,094

(22) Filed: Sep. 27, 2006

(30) Foreign Application Priority Data
Sep. 27, 2005 (DE) 10 2005 046 164.6

(51) Int. Cl. G01T 1/20

(52) U.S. Cl. 250/370.11

(57) ABSTRACT

An x-ray detector has a detector housing in which a base element is arranged that has a fiber optic. The fiber optic is optically coupled with a scintillator layer that is arranged on the top side of the base element and with a photosensor that is arranged over an optically-transparent adhesive layer on the underside of the base element. Such an x-ray detector exhibits a compact structural shape and a large active surface.

### BACKGROUND OF THE INVENTION

1. Field of the Invention

The present invention concerns an x-ray detector.

2. Description of the Prior Art

An x-ray detector with a detector housing in which is arranged a carrier plate is known from U.S. Pat. No. 5,912,942. The carrier plate is formed as a ceramic substrate with printed electrical conductor traces (PCB—printed circuit board) and has an electrical and electronic circuit. A photosensor (for example a CCD or CMOS chip) is arranged on the carrier plate. A fiber optic (glass fiber plate, FOP—fiber optical plate) is attached on the photosensor and a scintillator layer is attached in turn on this fiber optic. The x-ray radiation striking the scintillator layer is converted by this layer into visible light that is conducted to the photosensor via the fiber optic. The generated electrical signals are supplied from the photosensor to at least one output conductor (output line) via bond wires.

The optical coupling between the scintillator layer and the photosensor is achieved via the fiber optic, but a portion of the x-ray radiation (approximately 30%) that passes through the scintillator layer is attenuated by the fiber optic. Radiation damage as well as direct conversions in the photosensor that would lead to severe noise in the photodetector, and thus to an impairment of the image quality, are thereby largely avoided.

Due to the design configuration (glass fiber plate fashioned as a fiber optic and electrical contacting via bond wires), the x-ray detector according to U.S. Pat. No. 5,912,942 exhibits a relatively large installation height as well as a relatively large area.

For dental applications, an intra-oral x-ray detector is known from U.S. Pat. No. 5,434,418 in which the generated electrical signals are also conducted from the photosensor to at least one output conductor via bond wires.

The x-ray detector according to U.S. Pat. No. 5,434,418 exhibits a thickness of less than 3 mm. In order to achieve this low installation height, the scintillator layer is arranged directly on the photosensor. Due to the absence of a fiber optic, radiation damage as well as direct conversions in the photosensor can occur.

### SUMMARY OF THE INVENTION

An object of the present invention is to provide x-ray detector that exhibits a compact structural shape with a large active surface.

This object is achieved in accordance with the invention by an x-ray detector having a detector housing in which is a base element contained that has a fiber optic, the fiber optic being optically coupled with a scintillator layer, that is arranged on the top side of the base element, and with a photosensor, that is arranged on the underside of the base element, via an optically-transparent adhesive layer.

The base element of the x-ray detector in accordance with the invention serves as a substrate for the scintillator layer and embodies the fiber optic. A small installation height and a reliable attenuation of the remaining x-ray radiation passing through the scintillator layer are thereby achieved in the x-ray detector according to the invention.

Despite the low installation height of the inventive x-ray detector, radiation damage as well as direct conversions in the photosensor are avoided, with the described consequences.

An embodiment of the x-ray detector in which the base element has electrical terminals on its external side and the detector housing has corresponding electrical terminals on its inner side, the electrical terminals being connected with one another via at least one electrically-conductive connection, also exhibits a reduced installation height.

A reduced area requirement is achieved in an embodiment of the x-ray detector in which the electrical terminals are formed as electrical conductor traces with electrical contact surfaces and the electrically-conductive connection is produced via an electrical bond between the corresponding electrical contact surfaces and via a further electrical bond with the photosensor.

The base element can be mechanically fixed in the detector housing. A mechanical fixing of the base element via at least one gradation on the inside of the detector housing is particularly installation-friendly.

### DESCRIPTION OF THE DRAWINGS

FIG. 1 is a section through an x-ray detector according to the prior art.

FIG. 2 is a section through an embodiment of an x-ray detector according to the invention.

### DESCRIPTION OF THE PREFERRED EMBODIMENTS

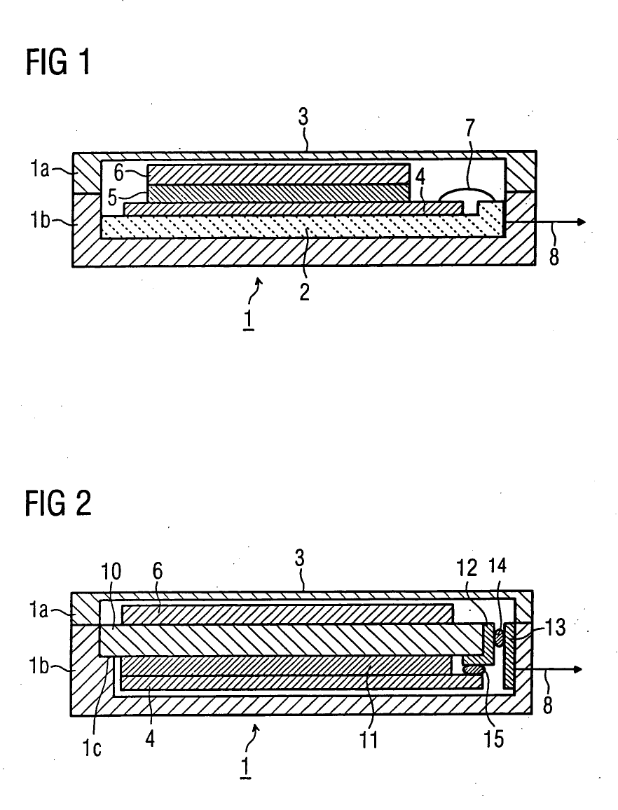

The known x-ray detector of FIG. 1 has a detector housing 1 containing a carrier plate 2. The housing 1 has an upper housing part 1a and a lower housing part 1b. The carrier plate 2 is fixed in the lower housing part 1b. A window 3 that is permeable only for x-ray radiation and impermeable for visible light is arranged in the upper housing part 1a.

The carrier plate 2 is formed as a ceramic substrate with printed electrical conductor traces (PCB—printed circuit board) forming an electrical circuit that, for clarity, is not shown in FIG. 1. A photosensor 4 (for example a CCD or CMOS chip) is arranged on the carrier plate 2. A fiber optic 5 (glass fiber plate, FOP—fiber optical plate) is attached on the photosensor 4 and a scintillator layer 6 is attached in turn on this fiber optic 5. The scintillator layer 6 is arranged directly after the window 3. Via bond wires 7 (of which only one is shown in FIG. 1), the photosensor 4 is connected in an electrically-conductive manner with the electrical conductor traces printed on the carrier plate 2. The electrical conductor traces printed on the carrier plate 2 are connected with at least one output conductor 8.

The x-ray radiation entering into the detector housing 1 through the window 3 impinges on the scintillator layer 6 and is converted by this into visible light that is relayed to the photosensor 4 via the fiber optic 5. The electrical signals generated in the photosensor 4 are relayed from the photosensor 4 to the output conductors 8 via the bond wires 7.

The embodiment of an inventive x-ray detector shown in FIG. 2 likewise has a detector housing 1 that has an upper housing part 1a and a lower housing part 1b. A window 3 that is permeable only for x-ray radiation and is impermeable for visible light is arranged in the upper housing part 1a.

A base element 10 that embodies the function of the fiber optic 5 of the known detector of FIG. 1 is arranged in the detector housing 1. In the shown exemplary embodiment the base element 10 is formed by glass fibers that are combined into a solid plate (glass fiber plate, FOP—fiber optical plate).

The fiber optic 3 embodied in the base element 10 is optically coupled with a scintillator layer 6 that is arranged on the top side of the base element 10. Furthermore, the fiber optic 3 of the base element 10 is optically coupled with a photosensor 4 that is arranged over an optically transparent adhesive layer 11 on the underside of the base element 10. The one optically transparent adhesive layer 11 can be, for example, an epoxy resin.

The optical coupling between the scintillator layer 7 and the photosensor 4 is achieved by the fiber optic of the base element 10, and the portion of x-ray radiation that passes through the scintillator layer 6 is attenuated by the fiber optic. Radiation damage as well as direct conversions in the photosensor 4 (that would lead to severe noise in the photodetector 4 and thus to an impairment of the image quality) are thereby largely prevented.

In the embodiment shown in FIG. 2, the base element 10 has at least one electrical conductor trace on its external side. The lower housing part 1b likewise comprises at least one electrical conductor trace 13 on its internal side. The electrical conductor traces 12 and 13 respectively exhibit corresponding (oppositely-situated) electrical contact surfaces that are connected with one another in an electrically-conductive manner via an electrical bond 14 (for example silver-containing epoxy glue).

The electrical conductor traces 12 arranged on the base element 10 exhibit at least one further electrical contact surface on the side facing towards the photosensor 4, which further electrical contact surface is connected in an electrically-conductive manner with the photosensor 4 via a further electrical bond.

The electrical conductor traces 13 are connected in an electrically-conductive manner with at least one output conductor 8. The electrical signals generated in the photosensor 4 are thereby relayed to the output conductor 8. By the arrangement of the electrical conductor traces 12 and 13 shown in FIG. 2 an optimally large active surface is obtained having an optimally small base area (footprint). The design configuration according to FIG. 2 is particularly suitable for an intra-oral x-ray detector (dental application) or for an x-ray detector in mammography applications.

The mechanical fixing of the base element 10 in the detector housing 1 is achieved in the shown exemplary embodiment by at least one circumferential gradation (step or shoulder) 1c on the inside of the lower housing part 1b, on which circumferential gradation 1c the underside of the base element 10 at least partially rests. The inner side on which the electrical conductor traces 13 are arranged exhibits no gradation. In the shown exemplary embodiment, the gradation 1c proceeds on one of the two facing sides and on the two longitudinal sides of the lower housing part 1b.

The circumferential gradation 1c on the inside of the lower housing part 1b can, for example, be milled out from the lower housing part 1b. A shaping in a casting or injection molding method can also be realized.

The base element 10 used in the shown embodiment of the inventive x-ray detector simultaneously fulfills a number of functions. The base element 10 serves as a substrate or as a carrier for the scintillator layer 6 and the photosensor 4 and moreover embodies the fiber optic. Furthermore, the electrical conductor traces with their contact surfaces are arranged in part on the surface of the base element 10.

Moreover the sensor arrangement (scintillator layer 6, fiber optic and photosensor 4) is reliably fixed in the detector housing 1 by the base element 10 in a simple manner.

Although modifications and changes may be suggested by those skilled in the art, it is the intention of the inventor to embody within the patent warranted hereon all changes and modifications as reasonably and properly come within the scope of his contribution to the art.

I claim as my invention:

1. An x-ray detector comprising:
a detector housing;
a base element contained in said detector housing, said base element comprising a fiber optic embodied therein, said base element having a top side and an underside;
a scintillator layer disposed on said top side of said base element and being optically coupled with said fiber optic embodied in said base element; and
a photosensor attached to the underside of said base element with an optically-transparent adhesive, said photosensor also being optically coupled with said fiber optic embodied in said base element.

2. An x-ray detector as claimed in claim 1 comprising electrical contacts on said base element and corresponding electrical contacts at an interior of said detector housing, and an electrically conductive connection between said contacts and said terminals.

3. An x-ray detector as claimed in claim 2 wherein said base element comprises electrical conductor traces thereon terminating with contact surfaces forming said contact, and wherein said electrically conductive connection comprises an electrically conductive bond between said contact surfaces and said terminals.

4. An x-ray detector as claimed in claim 3 comprising a further electrically conductive connection between said contact surfaces and said photosensor.

5. An x-ray detector as claimed in claim 4 wherein said further electrically conductive connection comprises a further electrical bond between said contact surfaces and said photosensor.

6. An x-ray detector as claimed in claim 1 wherein said base element is mechanically fixed in said detector housing.

7. An x-ray detector as claimed in claim 6 wherein said detector housing has an interior with at least one interior surface gradation, in which said base element is held.
